(19) United States
(12) Patent Application Publication
(10) Pub. No.: US 2022/0282653 A1
(43) Pub. Date: Sep. 8, 2022

(54) APPARATUS AND METHOD FOR CONTROLLING REDUCTION SYSTEM

(71) Applicant: JAGUAR LAND ROVER LIMITED, Coventry (GB)

(72) Inventor: Bhanuprakash HARANAHALLI PANCHAKSHARI, Coventry (GB)

(21) Appl. No.: 17/689,494

(22) Filed: Mar. 8, 2022

(30) Foreign Application Priority Data
Mar. 8, 2021 (GB) GB2103161.2

(51) Int. Cl. F01N 3/20; F01N 3/035

(52) U.S. Cl. CPC F01N 3/208; F01N 3/035; F01N 2250/02; F01N 2570/14; F01N 2610/02; F01N 2610/146; F01N 2900/0601; F01N 2900/10

(57) ABSTRACT

A control system for a vehicle, the control system having one or more controllers, the control system being arranged to: determine a prediction of an end of a current driving cycle of the vehicle, determine a likelihood of a regeneration event of an emission control device in a next driving cycle of the vehicle, and reduce a reductant loading of a selective catalyst reduction system of the vehicle prior to the end of the current driving cycle in dependence on the likelihood of the regeneration event.

### TECHNICAL FIELD

The present disclosure relates to controlling a reduction system. Aspects of the invention relate to a control system, to a vehicle, to a method and computer software.

### BACKGROUND

To reduce harmful emissions from internal combustion engine (ICE) vehicles, it is known for an exhaust system of the ICE to include aftertreatment devices. The aftertreatment devices may be provided to reduce at least particulate emissions and emission of oxides of nitrogen such as NOx. The aftertreatment devices may include one or more of a diesel particulate filter (DPF), gasoline particulate filter (GPF), lean NOx trap (LNT), a reductant injection system and a selective catalyst reduction (SCR) system.

At least some of the aftertreatment devices have different operating characteristics, such as temperature, and act in combination to reduce emissions from the vehicle. Therefore appropriate control of each aftertreatment device is required for effective reduction in emissions.

### SUMMARY OF THE INVENTION

It is an aim of the present invention to address one or more of the disadvantages associated with the prior art.

Aspects and embodiments of the invention provide a control system, a vehicle, a method and computer software as claimed in the appended claims

According to an aspect of the present invention there is provided a control system for a vehicle, the control system comprising one or more controller, the control system being arranged to determine a prediction of an end of a current driving cycle of the vehicle and to reduce a reductant loading of a selective catalyst reduction system of the vehicle prior to the end of the current driving cycle. Advantageously the reductant loading is controlled prior to the end of the current driving cycle to improve emissions in a next driving cycle. Advantageously slippage from the selective catalyst reduction system during a regeneration event may be reduced.

A control system for a vehicle, the control system comprising one or more controller, the control system being arranged to determine a likelihood of an upcoming regeneration event of an emission control device of the vehicle, and control a reductant loading of first and second selective catalyst reduction systems of the vehicle in dependence on the likelihood of the upcoming regeneration event. Advantageously the reductant loading of the first and second selective catalyst reduction systems is controlled to manage emissions during the regeneration event. Advantageously slippage from the selective catalyst reduction system during the regeneration event may be reduced. Advantageously reductant consumption may be reduced, and consequently reduced refills of reductant required.

According to aspect of the invention, there is provided a control system for a vehicle, the control system comprising one or more controller, the control system being arranged to determine a prediction of an end of a current driving cycle of the vehicle, determine a likelihood of a regeneration event of an emission control device in a next driving cycle of the vehicle, and reduce a reductant loading of a selective catalyst reduction system of the vehicle prior to the end of the current driving cycle in dependence on the likelihood of the regeneration event. Advantageously the reductant loading is controlled prior to the end of the current driving cycle to improve emissions in a next driving cycle. Advantageously slippage from the selective catalyst reduction system during a regeneration event may be reduced.

Optionally the control system comprises an output arranged to output a reductant control signal for controlling the reductant loading of the selective catalyst reduction system. Advantageously the control system controls the reductant loading via the reductant control signal. The control system may comprise an input for receiving a signal indicative of the likelihood of the regeneration event. Advantageously the likelihood of the regeneration event is indicated by the signal from another vehicle system.

The reductant control signal is optionally for controlling an injector associated with the selective catalyst reduction system. Advantageously the injector is arranged to control the reductant loading of the selective catalyst reduction system.

The determining the likelihood of the regeneration event of the emissions control device may comprise determining a likelihood of the regeneration event within a predetermined period of time from a start of the next driving cycle. Advantageously the period of time may be the period to heat the selective catalyst reduction system. The predetermined period of time may be at least 15 minutes. The predetermined period of time may be around 20 minutes.

The start of the next driving cycle is optionally determined from a start of an engine of the vehicle. Advantageously the engine operatively heats the selective catalyst reduction system.

The reducing the reductant loading may comprise substantially depleting the selective catalyst reduction system of reductant prior to the end of the current driving cycle. Advantageously the selective catalyst reduction system is generally empty of reductant ready for the regeneration event.

The depleting the selective catalyst reduction system of reductant prior to the end of the current driving cycle may comprise outputting the reductant control signal to control the injector to reduce injection of the reductant, such that the selective catalyst reduction system is substantially unloaded prior to the end of the current driving cycle.

The selective catalyst reduction system is optionally substantially unloaded prior to the end of the current driving cycle. Advantageously the selective catalyst reduction system is ready for the regeneration event.

The reductant loading of the selective catalyst reduction system may be reduced at least 5 minutes prior to the end of the current driving cycle. Advantageously there is sufficient time to deplete the selective catalyst reduction system of reductant. The reductant loading of the selective catalyst reduction system may be reduced around 10 minutes prior to the end of the current driving cycle. Advantageously there is sufficient time to deplete the selective catalyst reduction system of reductant.

Optionally the control system is arranged to determine an end of the regeneration event of the emission control device and to increase the reductant loading of the selective catalyst reduction system of the vehicle in dependence on the end of the regeneration event. Advantageously the selective catalyst reduction system is prepared for operation once the regeneration event ends.

The selective catalyst reduction system may be a first selective catalyst reduction system located proximal to the emission control device in an exhaust system of the vehicle. The proximal selective catalyst reduction system may be heated by the regeneration event, which may cause slippage from the selective catalyst reduction system.

The control system may be arranged to increase a reductant loading of a second selective catalyst reduction system of the vehicle in dependence on the likelihood of the upcoming regeneration event. Advantageously the second selective catalyst reduction system may be prepared to operatively control emissions during the regeneration event. The second selective catalyst reduction system may be located distal to the emission control device in the exhaust system. Advantageously the distal second selective catalyst reduction system may be heated less than the first system by the regeneration event.

The second catalyst reduction system may be an underfloor selective catalyst reduction system. Advantageously the underfloor second selective catalyst reduction system may be generally thermally isolated from the regeneration event.

The emission control device may be a diesel particulate filter. The reductant may be a urea or an ammonia based reductant.

According to an aspect of the present invention there is provided a system for a vehicle, comprising a control system as described above, and a selective catalyst reduction system, wherein the control system is arranged to control a reductant loading of the selective catalyst reduction system.

The system may comprise a reductant injector controlled by the control system, wherein the injector is arranged to inject reductant to the selective catalyst reduction system.

According to an aspect of the present invention there is provided a vehicle comprising the control system or the system as described above.

According to an aspect of the present invention there is provided a method of controlling a selective catalyst reduction system, the method comprising determining a prediction of an end of a current driving cycle of the vehicle, determining a likelihood of a regeneration event of an emission control device in a next driving cycle of the vehicle, and reducing a reductant loading of a selective catalyst reduction system of the vehicle prior to the end of the current driving cycle in dependence on the likelihood of the regeneration event.

The method may comprise outputting a reductant control signal for controlling the reductant loading of the selective catalyst reduction system.

The method may comprise receiving a signal indicative of the likelihood of the regeneration event of the emission control device in the next driving cycle of the vehicle.

The method may comprise depleting the selective catalyst reduction system of reductant prior to the end of the current driving cycle.

The method may comprise determining an end of the regeneration event of the emission control device, and increasing the reductant loading of the selective catalyst reduction system of the vehicle in dependence on the end of the regeneration event.

The selective catalyst reduction system may be a first selective catalyst reduction system located proximal to the emission control device in an exhaust system of the vehicle. The method may comprise increasing a reductant loading of a second selective catalyst reduction system of the vehicle in dependence on the likelihood of the upcoming regeneration event. The second selective catalyst reduction system may be located distal to the emission control device in the exhaust system.

The method may comprise controlling an injector associated with the selective catalyst reduction system to reduce the reductant loading of the selective catalyst reduction system of the vehicle prior to the end of the current driving cycle in dependence on the likelihood of the regeneration event.

According to an aspect of the present invention there is provided computer software which, when executed by a computer, is arranged to perform a method as described above.

According to an aspect of the present invention there is provided a control system for a vehicle, the control system comprising one or more controller, the control system being arranged to determine a likelihood of an upcoming regeneration event of an emission control device of the vehicle, and control a reductant loading of first and second selective catalyst reduction systems of the vehicle in dependence on the likelihood of the upcoming regeneration event, the first selective catalyst reduction system being located proximal to the emission control device in an exhaust system of the vehicle, and the second selective catalyst reduction system being located distal to the emission control device in the exhaust system. Advantageously slippage and/or reductant consumption from the first selective catalyst reduction system is reduced, whilst maintaining emissions control using the second selective catalyst reduction system.

Proximal may be understood to mean that the emission control device and selective catalyst reduction system are in thermal communication. The first selective catalyst reduction system may be heated by the regeneration even of the emission control device, which may cause slippage. Advantageously the second selective catalyst reduction system being located distal to the emission control device reduces heating during the regeneration event.

The control system may be arranged to control the loading of the first and second selective catalyst reduction systems of the vehicle by reducing a reductant loading of the first selective catalyst reduction system in dependence on the regeneration event. Advantageously the first selective catalyst reduction system is reduced in reductant loading during the regeneration event to thereby minimise slippage.

The control system may be arranged to control the loading of the first and second selective catalyst reduction systems of the vehicle prior to the regeneration event. Advantageously the reductant loading is controlled in anticipation of, or in advance of, the regeneration event.

The control system is optionally arranged to control the loading of the first and second selective catalyst reduction systems of the vehicle by increasing a reductant loading of the second selective catalyst reduction system in dependence on the regeneration event. Advantageously the second selective catalyst reduction systems is prepared to operatively control emissions during the regeneration event.

The control system may comprise an output arranged to output at last one reductant control signal for controlling the reductant loading of the first and second selective catalyst reduction systems. Advantageously the reductant control signal is able to control the reductant loading.

The control system may comprise an input for receiving a signal indicative of the likelihood of the regeneration event. Advantageously the signal provides an indication of the likelihood of the regeneration event from another vehicle system.

The reductant control signal optionally comprises a first reductant control signal for controlling the reductant loading of the first selective catalyst reduction system. Advantageously the reductant loading of the first selective catalyst reduction system may be independently controlled.

Optionally the reductant control signal comprises a second reductant control signal for controlling the reductant loading of the second selective catalyst reduction system. Advantageously the reductant loading of the second selective catalyst reduction system may be independently controlled.

The reductant control signal may be for controlling a first injector associated with the first selective catalyst reduction system and a second injector associated with the second selective catalyst reduction system. Advantageously the injectors for injecting reductant to the respective selective catalyst reduction systems are operative to control the reductant loading.

Reducing the reductant loading of the first selective catalyst reduction system optionally comprises depleting the first selective catalyst reduction system of reductant in dependence on the upcoming regeneration event of the emission control device of the vehicle. Advantageously the first selective catalyst reduction system being depleted of reductant reduces slippage from the first selective catalyst reduction system during the regeneration event. The first selective catalyst reduction system may be depleted of reductant prior to a start of the regeneration event. Advantageously slippage from the first selective catalyst reduction system is further reduced.

The depleting the first selective catalyst reduction system of reductant comprises outputting the reductant control signal to control the first injector to reduce injection of the reductant, such that the first selective catalyst reduction system is substantially unloaded prior to the regeneration event. Advantageously the first selective catalyst reduction system is depleted of reductant by the reduced injection.

The control system is arranged to control the loading of the first and second selective catalyst reduction systems of the vehicle by increasing a reductant loading of the first selective catalyst reduction system in dependence on an end of the regeneration event. Advantageously the first selective catalyst reduction system is brought back into use in dependence on the end of the regeneration event.

The control system of any preceding claim, wherein the control system is arranged to control the loading of the first and second selective catalyst reduction systems of the vehicle by decreasing a reductant loading of the second selective catalyst reduction system in dependence on an end of the regeneration event. Advantageously use the second selective catalyst reduction system is reduced dependence on the end of the regeneration event.

The control system may be arranged to determine a prediction of an end of a current driving cycle of the vehicle. Advantageously control of one or more selective catalyst reduction systems of the vehicle may be performed in dependence on the prediction.

The control system may be arranged to determine the likelihood of the upcoming regeneration event of the emission control device in a next driving cycle of the vehicle. Advantageously the reductant loading of one or more selective catalyst reduction systems of the vehicle may be controlled in dependence on the likelihood.

The control system may be arranged to control the reductant loading of the first and second selective catalyst reduction systems of the vehicle in dependence on the likelihood of the upcoming regeneration event in the next driving cycle of the vehicle. Advantageously emissions of the vehicle in the next driving cycle may be controlled by controlling th reductant loading in a current driving cycle.

The determining the likelihood of the regeneration event of the emission control device may comprise determining a likelihood of the regeneration event within a predetermined period of time from a start of the next driving cycle. The predetermined period of time may be at least 15 minutes. The predetermined period of time may be around 20 minutes.

The emission control device is optionally a diesel particulate filter. The reductant may be a urea or an ammonia based reductant.

According to an aspect of the present invention there is provided a system for a vehicle, comprising a control system as described above, first and second selective catalyst reduction systems, wherein the control system is arranged to control a reductant loading of the first and second selective catalyst reduction systems.

The system may comprise a first reductant injector controlled by the control system, wherein the first reductant injector is arranged to inject reductant to the selective catalyst reduction system.

The system may comprise a second reductant injector controlled by the control system, wherein the second reductant injector is arranged to inject reductant to the second selective catalyst reduction system.

According to an aspect of the present invention there is provided a vehicle comprising the control system or the system as described above.

According to an aspect of the present invention there is provided a method of controlling a selective catalyst reduction system, the method comprising determining a likelihood of an upcoming regeneration event of an emission control device of a vehicle, controlling a reductant loading of first and second selective catalyst reduction systems of the vehicle in dependence on the likelihood of the upcoming regeneration event, the first selective catalyst reduction system being located proximal to the emission control device in an exhaust system of the vehicle, and the second selective catalyst reduction system being located distal to the emission control device in the exhaust system.

The controlling the loading of the first and second selective catalyst reduction systems of the vehicle may comprise reducing a reductant loading of the first selective catalyst reduction system prior to the regeneration event.

The controlling the loading of the first and second selective catalyst reduction systems of the vehicle may comprise increasing a reductant loading of the second selective catalyst reduction system prior to the regeneration event.

The method may comprise outputting a reductant control signal for controlling the reductant loading of the first and second selective catalyst reduction systems.

Reducing the reductant loading of the first selective catalyst reduction system may comprise depleting the first selective catalyst reduction system of reductant prior to the upcoming regeneration event of the emission control device of the vehicle.

Reducing the reductant loading of the first selective catalyst reduction system may comprise depleting the first selective catalyst reduction system of reductant prior to a start of the regeneration event

The method may comprise determining a prediction of an end of a current driving cycle of the vehicle.

The method may comprise determining the likelihood of the upcoming regeneration event of the emission control device in a next driving cycle of the vehicle.

The method may comprise controlling the reductant loading of the first and second selective catalyst reduction systems of the vehicle in dependence on the likelihood of the upcoming regeneration event in the next driving cycle of the vehicle.

According to an aspect of the present invention there is provided computer software which, when executed by a computer, is arranged to perform a method as described above.

According to an aspect of the present invention there is provided a non-transitory, computer-readable storage medium storing instructions thereon that, when executed by one or more electronic processors, causes the one or more electronic processors to carry out a method as described above.

The one or more controller of a control system according to the present invention may collectively comprise at least one electronic processor having an electrical input for receiving one or more input signals and at least one memory device electrically coupled to the at least one electronic processor and having instructions stored therein.

The at least one electronic processor may be configured to access the at least one memory device and execute the instructions thereon so as to determine a prediction of an end of a current driving cycle of the vehicle and to reduce a reductant loading of a selective catalyst reduction system of the vehicle prior to the end of the current driving cycle.

The at least one electronic processor may be configured to access the at least one memory device and execute the instructions thereon so as to determine a likelihood of an upcoming regeneration event of an emission control device of the vehicle, and control a reductant loading of first and second selective catalyst reduction systems of the vehicle in dependence on the likelihood of the upcoming regeneration event.

The at least one electronic processor may be configured to access the at least one memory device and execute the instructions thereon so as to determine a prediction of an end of a current driving cycle of the vehicle, determine a likelihood of a regeneration event of an emission control device in a next driving cycle of the vehicle, and reduce a reductant loading of a selective catalyst reduction system of the vehicle prior to the end of the current driving cycle in dependence on the likelihood of the regeneration event.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a system according to an embodiment of the present invention;

FIG. 2 shows a vehicle according to an embodiment of the present invention;

FIG. 3 shows an efficiency of an emission reduction system;

FIG. 4 shows a method according to an embodiment of the present invention;

FIG. 5 shows operating conditions with respect to an emission reduction system according to an embodiment of the present invention;

FIG. 6 illustrates a method according to another embodiment of the present invention;

FIG. 7 illustrates a system according to an embodiment of the present invention; and

FIG. 8 shows operating conditions with respect to emission reduction system according to another embodiment of the present invention.

### DETAILED DESCRIPTION

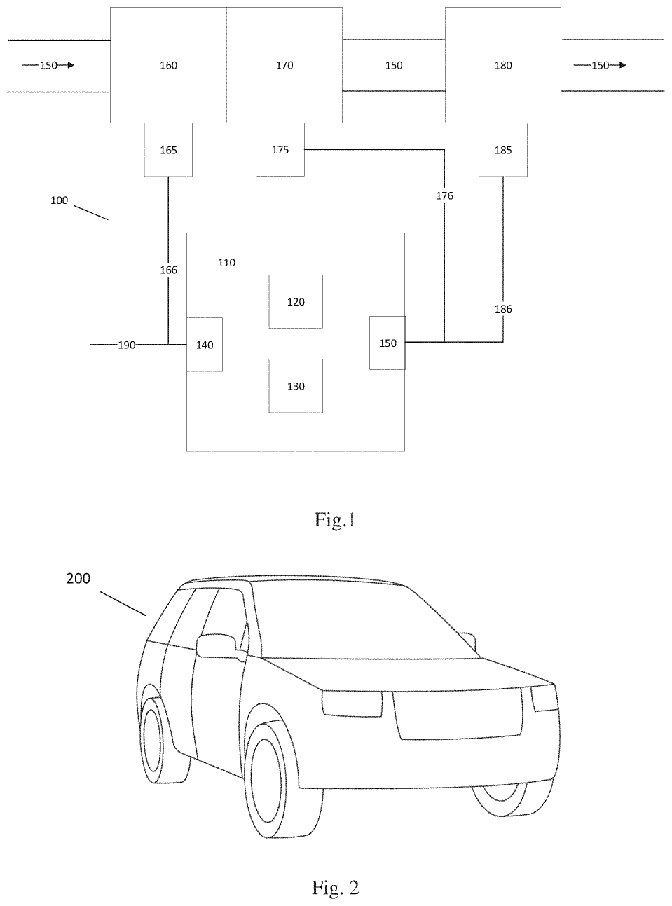

A system 100 in accordance with an embodiment of the present invention is described herein with reference to the accompanying FIG. 1. The system 100 comprises a control system 110 according to an embodiment of the invention and a plurality of emissions aftertreatment devices 160, 170, 180. An exhaust system 150 of a vehicle 200, such as that illustrated in FIG. 2, is associated with the plurality of aftertreatment devices 160, 170, 180. The exhaust system 150 receives gaseous emissions from an internal combustion engine (ICE) of the vehicle 200 and provides a passageway for the emissions via the aftertreatment devices 160, 170, 180, as indicated by arrows in FIG. 1.

The aftertreatment devices 160, 170, 180 comprise a first aftertreatment device 160 having an intermittent high-temperature operation. The high-temperature operation of the first aftertreatment device 160 may be a purge or regeneration operation which reduces emissions stored in the device at least partly by heating the device 160. For example, the first aftertreatment device 160 may be an emissions control device 160 or emissions trap 160.

The emissions trap 160 may be a NOₓ adsorber, NOₓ trap or a lean NOₓ trap (LNT) 160, a diesel particulate filter (DPF) or a gasoline particulate Filter (GPF). The emissions trap 160 may include a catalyst which captures the oxides of nitrogen or particulates. The emissions trap 160 has a predetermined maximum capacity, such as 2 g (other maximum capacities can be envisaged). Once the emissions trap 160 reaches its maximum capacity, it is not capable of capturing, e.g. further oxides of nitrogen, which then pass through the emissions trap 160 and is known as slippage. The purge operation can be performed to purge or remove the captured oxides of nitrogen e.g. NOₓ or particulates from the emissions trap 160, thereby regenerating the emissions trap 160. Hereinafter the emissions trap 160 will be referred to as the LNT 160 for clarity. During the purge operation, slippage is caused i.e. oxides of nitrogen are released from the emissions trap 160 into the exhaust system 150. The released oxides of nitrogen may be captured or treated downstream in the exhaust system 150 of the emissions trap 160, such as at one of the more of the other aftertreatment devices 170, 180 downstream of the emissions trap 160.

The purge or regeneration event may increase a temperature of the emissions trap 160 to an elevated operating temperature. The elevated operating temperature may be around 600° C. or above, for example for the DPF diesel particulate matter burns at such temperatures, although it will be appreciated that the exact temperature may depend on a variety of factors.

The purge operation may utilise a rich lambda (i.e. <1) operation of the ICE, as will be appreciated. The regeneration operation may be performed when a temperature of the exhaust 150 of the vehicle 200 is relatively hot i.e. above a predetermined temperature, such that the higher temperature provides a higher activation energy for a chemical reaction required to unload the catalyst of the LNT 160 of oxides of nitrogen.

Associated with the first aftertreatment device 160, such as the LNT or DPF 160, is a device 165 which is used to determine a likelihood of the regeneration operation being required, as will be explained. The device 165 is arranged to output a signal 166 to the control system 110.

The system 100 comprises at least one selective catalyst reduction (SCR) system 170, 180. In some embodiments, the system 100 comprises two or more SCRs systems 170, 180. In the embodiment illustrated in FIG. 1 the system comprises two SCRs 170, 180 with it being appreciated that this is not restrictive. The illustrated system 100 comprises first and second SCR systems 170, 180. An SCR 170, 180 is a emissions reduction system comprising a catalyst which operates to reduce emissions of oxides of nitrogen such as nitrogen oxide, NOₓ. A reductant, often in liquid form, is introduced to convert the oxides of nitrogen to other, less harmful, compounds or elements. The reductant may be ammonia or urea based. Associated with each of the SCRs 170, 180 is an injector 175, 185 for injecting the liquid reductant into the exhaust system 150 for use by the respective SCR 170, 180. Thus the illustrated system comprises a first injector 175 associated with the first SCR 170 and a second injector 185 associated with the second SCR 180. In a system 100 comprising only one SCR, such as the first SCR 170, only the first injector 175 associated with the first SCR 170 is required as will be appreciated.

Each of the first and second injectors 175, 185 is operative responsive to a respective reductant control signal 176, 186 provided from the control system 110. The reductant control signals 176, 186 comprise a first reductant control signal 176 and a second reductant control signal 186 which each control a loading of the respective first and second SCRs 170, 180 with reductant. Thus the control system 110 is operative to control the first and second injectors 175, 185 via the first and second reductant control signals 176, 186 to control the loading of the first and second SCRs 170, 180 with reductant.

The first SCR 170 is located proximal or relative close to the emissions trap 160. The first SCR 170 may be in thermal communication with the emissions trap 160, such as the LNT 160, DPF or GPF 160. The first SCR 170 may be referred to as a close-coupled SCR 170 or CCSCR 170 indicative of the relatively close placement or co-location of the first SCR 170 and emissions trap 160. The purge or regeneration event associated with the emissions trap 160 therefore raises the temperature of the first SCR 170. The raised temperature may cause slippage from the first SCR 170 as will be explained. In embodiments comprising a second SCR 180, the second SCR 180 is located further away or distal from the emissions trap 160. That is, the second SCR 180 is in reduced thermal communication with the emissions trap 160 compared to the first SCR 170. As such the second SCR 180 is not heated by the regeneration event of the emissions trap 160 as much as the first SCR 170. The second SCR 180 may be referred to as a distal SCR 180 or DSCR 180. Thus during the regeneration event the second SCR 180 is at a lower temperature than the first SCR 170. The second SCR 180 may be located in a region of a floor of the vehicle 200, such as in an underfloor location, although it will be appreciated that other mounting locations may be envisaged.

The control system 110 may be formed by one or more controller 110 which comprises processing means 120 and memory means 130. The processing means 120 may be one or more electronic processing devices 120 or processors 120 which operably execute computer-readable instructions. The memory means 130 may be one or more memory devices 130. The memory means 130 is electrically coupled to the processing means 120. The memory means 130 is configured to store computer-readable instructions, and the processing means 120 is configured to access the memory means 130 and execute the instructions stored thereon.

The control system 110 further comprises an input means 140 which may be an electrical input to receive one or more electrical signals 166, 190. The control system 110 may comprise an output means 150 which may be an electrical output 150 for outputting one or more control signals 176, 186 under control of the processor 120. In some embodiments, the input 140 is arranged to receive a load signal 166 indicative of a load of the emissions trap 160. The load signal 166 may be indicative of a load of the LNT 160 i.e. indicative of an amount of NOₓ adsorbed in the LNT 160. The load signal 166 may be indicative of a load of the DPF 160 in some embodiments. The load signal 166 may be provided by a device 165 associated with the LNT 160 or the DPF 160 for measuring the load thereof.

For the LNT 160, the device 165 may be a NOₓ sensor 165. In some embodiments, the NOx sensor 165 may comprise a plurality of NOₓ sensors 165. A first NOₓ sensor may be arranged to measure NOₓ emitted from the ICE upstream of the LNT 165 and a second NOₓ sensor may be arranged to measure NOₓ downstream of the LNT 160. The processor 120 may be arranged to determine the NOₓ load on the signals from the first and second NOₓ sensors. In one embodiment, the processor 120 may be arranged to determine integration of an output of the first NOₓ sensor minus an integration of an output of the second NOₓ sensor to determine the NOₓ load of the LNT 160.

For the DPF or GPF 160, the device 165 may comprise one or more pressure sensors. In one embodiment, a first pressure sensor is arranged upstream of the DPF or GPF and a second pressure sensor is arranged downstream of the DPF or GPF. Pressure signals output by the first and second pressure sensors may be used to determine a differential pressure across the DPF or GPF which is indicative of a load of the DPF or GPF i.e. a soot load stored in the DPF/GPF 160. In some embodiments, alternatively or additionally, a particulate filter may be used to determine a filtration efficiency of the DPF/GPF from which the load of the DPF/GPF 160 may be determined.

In other embodiments, the processor 120 may infer the load of emissions trap 160 without direct measurement, such as from data indicative of an output of oxides of nitrogen, such as NOₓ, by the internal combustion engine (ICE) of the vehicle 200 according to a load on the ICE.

In some embodiments, the control system 110, hereinafter controller 100, may receive a signal 190 indicative of a prediction of an end of driving cycle (EoDC) event, as will be explained.

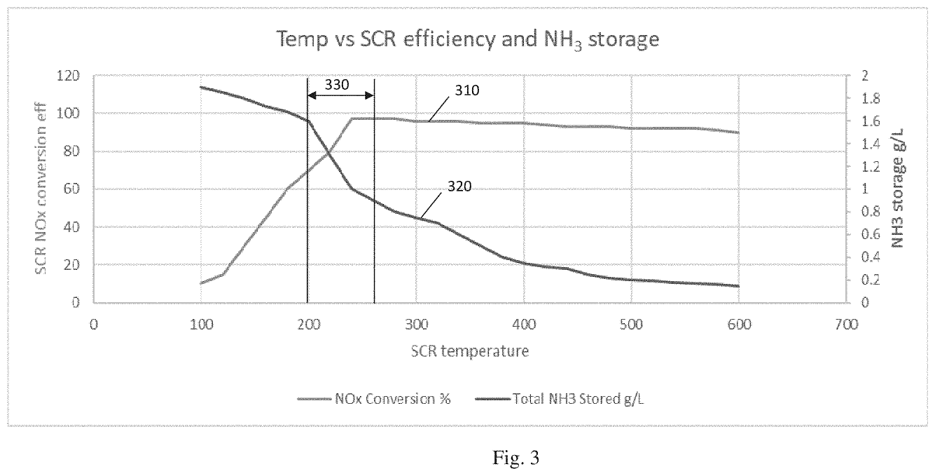

FIG. 3 illustrates temperature against an operating efficiency 310 and an ammonia storage capacity 320 of an example SCR, such as the first or second SCRs 170,180. The operating efficiency 310 is a conversion efficiency of converting NOₓ emissions from the ICE to harmless nitrogen (N₂) and water (H₂O) using the stored ammonia. The operating efficiency is determined in dependence on the conversion efficiency 310 which is an efficiency of converting NOR, which may be defined as a percentage as in FIG. 3. The operating efficiency is determined in dependence on an ammonia storage capacity 320 which is defined as a storage capacity of ammonia (NH₃) per unit of catalyst volume, which in the example of FIG. 3 is in units of g of NH₃ per litre (g/L) of catalyst volume. Thus the operating efficiency of the SCR is a function of the conversion efficiency and storage ammonia storage capacity. As can be appreciated from FIG. 3, the operating efficiency of the SCR at low temperatures is dominated by the increasing conversion efficiency 310 and increases with temperature, up to a threshold temperature at which the conversion efficiency substantially reaches a maximum of around 90% or around 96% depending on chemical formulation by way of example, above which temperature the conversion efficiency may actually decrease slightly with increasing temperature. The threshold temperature may be a temperature associated with the exhaust system 150 such as an operating temperature of the SCR 170, 180 being at least 150° C. or at least 200° C. Meanwhile, the ammonia storage capacity 320 of the SCR reductant is observed to reduce with increasing temperature. Therefore, as can be appreciated from FIG. 3, a peak operating efficiency window 330 of temperature exists for the SCR between first and second temperatures which balances increasing conversion efficiency of the SCR 180 with reducing storage capacity of the reductant. An upper temperature threshold of the operating efficiency window may be less than 300° C. or Less than 275° C. For a close-coupled SCR, such as the first SCR 170, the regeneration event of the proximal emissions trap 160 increases the temperature of the SCR 170 such that, particularly, the ammonia storage capacity reduces as shown in FIG. 3 thereby reducing the operating efficiency of the SCR. The regeneration event of the emissions trap 160 may cause the temperature of the close-coupled SCR 170 to increase so as to be outside of the operating efficiency window 330. In embodiments of the invention, the controller 110 is arranged to control the reductant loading of the close-coupled SCR 170 in dependence on the regeneration event, as will be explained. In some embodiments, the controller 110 is arranged control the reductant loading of the first and second SCRs 170, 180 in dependence on a likelihood of an upcoming regeneration event.

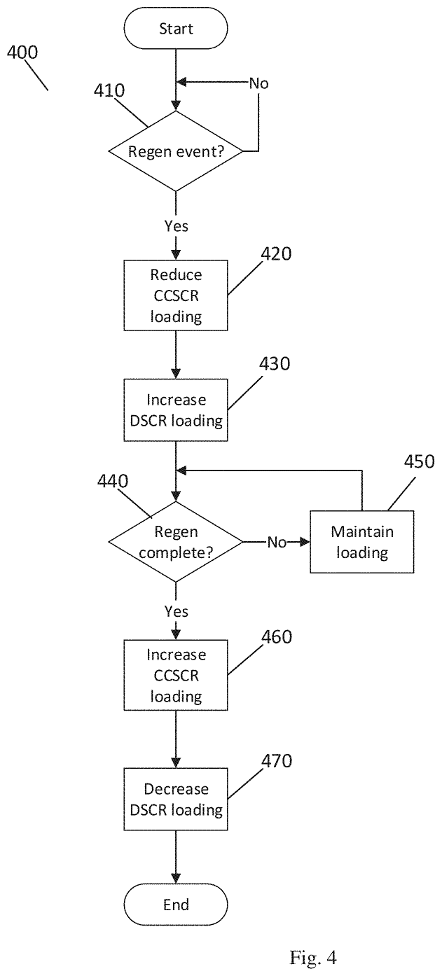

FIG. 4 illustrates a method 400 according to an embodiment of the invention. The method 400 is a method for controlling a reductant loading of one or more SCRs. The method 400 may be performed by the system 100 shown in FIG. 1. The memory 120 of the controller 110 may store computer readable instructions which, when executed by the processor 110, perform an embodiment of the method 400.

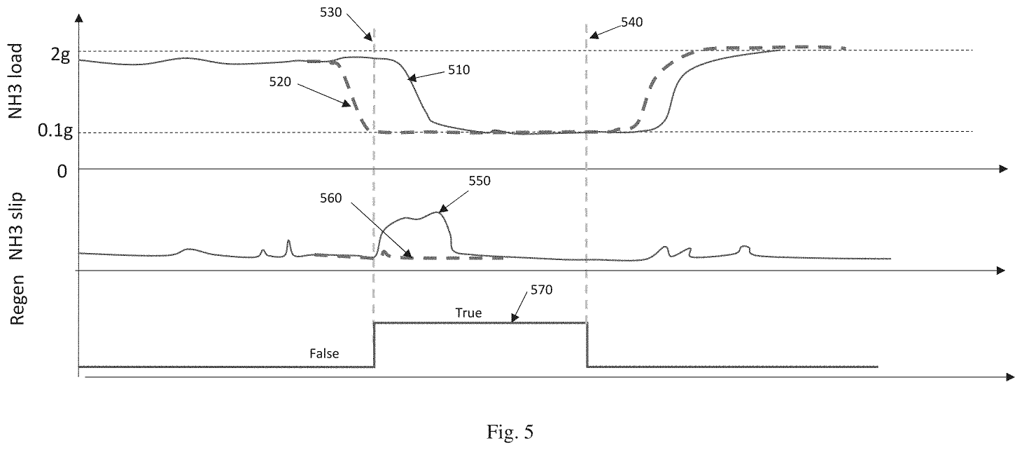

The method 400 of FIG. 4 will be explained with reference to FIG. 5 which illustrates ammonia (NH₃) load and slip of an SCR in relation to a regeneration event 570 of an emissions trap 160. Illustrated in an upper portion of FIG. 5 is an ammonia load of the close-coupled SCR 170 in relation to the regeneration event of the emissions trap 160. A trace 510 is indicative of a prior art, reactive, reductant loading of the SCR 170 whereas pre-emptive reductant loading according to an embodiment of the invention is illustrated as dashed trace 520. Similarly, slippage from the SCR according to the prior art example is illustrated as 550 with slippage from the SCR 170 according to an embodiment of the invention is illustrated as 560. The regeneration event 570 is indicated as a regeneration signal 570 having two values false i.e. not regenerating or purging and true or high corresponding to the regeneration event, the time period of which is indicated as a beginning 530 of the regeneration event and an end 540 of the regeneration event.

Referring to FIG. 4, the method 400 comprises a block 410 of determining a likelihood of an upcoming regeneration event 570 of an emission control device 160 or emission trap 160 of the vehicle 200. Block 410 may comprise receiving the load signal 166. As noted above, the load signal 166 may be indicative of the load of the emissions trap 160. The load signal 166 may be indicative of a load of the LNT 160 i.e. indicative of an amount of NOₓ adsorbed in the LNT 160, or an amount of particulates captured by a DPF or GPF 160.

A remaining capacity of the LNT, DPF or GPF 160 may be determined in block 410. If the remaining capacity is relatively low, such as below a predetermined minimum threshold capacity, the controller 110 may determine in block 410 a likelihood of the regeneration event i.e. that it is necessary to regenerate or purge the LNT, DPF or GPF 160. The predetermined remaining minimum threshold capacity may be, for example, 25%, 15% or 10% of the total NOₓ capacity of the emissions trap 160. For example 25% of the total capacity may be 0.5 g of NOₓ for an LNT 160 with a maximum capacity of 2 g, although other capacities may be envisaged. If it is likely that a regeneration event 570 is necessary in block 410 the method 400 moves to block 420. If, however, there is not a likelihood of a regeneration event then the method may remain at block 410 i.e. may loop until there exists a likelihood of an upcoming regeneration event. The likelihood of the regeneration event 570 may be indicative of a regeneration event 570 within a predetermined period of time from execution of block 410. The predetermined period of time may be around 20 minutes, or at least 15 minutes, although other periods of time may be envisaged.

In block 420 a reductant loading of the close-coupled SCR 170 i.e. the first SCR 170 is reduced responsive to the regeneration event 470. In some embodiments, the reductant loading of the close-coupled SCR 170 i.e. the first SCR 170 is reduced prior to the regeneration event 570. Block 410 comprises the controller 110 controlling the reductant injected to the close-coupled SCR 170. In particular, embodiments of block 420 comprise the controller 110 outputting the first reductant control signal 176 to control the first injector 175 to reduce an amount or rate of ammonia reductant injected to the close-coupled SCR 170. The first injector 175 is controlled by the controller 110 to reduce the reductant load prior to the beginning 530 of the regeneration event 570. Referring to the upper portion of FIG. 5, it can be appreciated that, in some prior art systems the reductant load of the close-coupled SCR 170 is reduced in response to the regeneration event 570 beginning i.e. after time 530. However, in embodiments of the invention, the ammonia load is reduced prior to the beginning 530 of the regeneration event at time 530 by controlling the first injector 175 to reduce the injection of reductant prior to time 530 in dependence on the likelihood of the upcoming regeneration event 570. In some embodiments, as illustrated in FIG. 5, in block 420 the controller 110 is arranged to control the first injector 175 to depleting the close-coupled SCR 170 of reductant prior to the upcoming regeneration event. In some embodiments, the controller 110 is arranged to cause the close-coupled SCR 170 to be generally depleted of reductant prior to the beginning 530 of the regeneration event 570. In some embodiments, the close-coupled SCR 170 is generally depleted of reductant at substantially the same time as the beginning 530 of the regeneration event to advantageously avoid ammonia slippage during the regeneration event whilst still allowing the close-coupled SCR 170 to treat exhaust emissions up to the beginning 530 of the regeneration event 570. Block 410 may comprise the controller 110 being arranged to output the first reductant control signal 176 to control the first injector 175 to reduce injection of the reductant, such that the close-coupled SCR 170 is substantially unloaded prior to the regeneration event 570.

As can be appreciated from the middle portion of FIG. 5 showing a trace 550 indicating slippage from a reactive or prior art SCR when reductant is only reduced in dependence on i.e. after the beginning 530 of the regeneration event 570, ammonia slippage from the close-coupled SCR 170 occurs during the regeneration event 570 owing to the increased temperature of the close-coupled SCR 170. However, in embodiments of the invention, trace 560 illustrates slippage from the close-coupled SCR 170 which is reduced or depleted of ammonia prior to the beginning 530 of regeneration event 570, illustrating that slippage during the regeneration event 570 is advantageously reduced.

In block 430 a reductant loading of the distal SCR 180 (DSCR 180) i.e. the second SCR 180 is increased responsive to the regeneration event 570. In some embodiments, the reductant loading of the DSCR 180 is increased prior to the regeneration event 570. Block 430 comprises the controller 110 being arranged to increase a reductant loading of the second SCR 180 of the vehicle 200 in dependence on the likelihood of the upcoming regeneration event 570. In some embodiments the controller 110 is arranged to increase in block 430 the reductant loading of the DSCR 180 prior to the beginning 530 of the regeneration event 570. The reductant loading of the DSCR 180 may be increased proportional to the decrease in loading of the CCSCR 170. In other embodiments, the loading of the DSCR 180 may be increased in advance of the reduction in loading of the CCSCR 170, or in advance of the reduction in loading of the CCSCR 170. Advantageously the DSCR 180 is able to treat emissions from the ICE of the vehicle 200 as the CCSCR 170 reductant loading is reduced.

In block 440 it is determined whether the regeneration event 570 is complete i.e. whether the current time has reached the end 540 of the regeneration event 570 illustrated in FIG. 5. In some embodiments, block 440 may comprise determining whether the end 540 of the regeneration event 570 is within a predetermined time i.e. whether the regeneration event 570 has almost finished as, advantageously, this may allow for an increase in reductant loading of the CCSCR 170 to made more closely at the time 570 of the regeneration event ending in block 460. If the regeneration event 570 is not complete, or not almost complete, the method moves to step 450 wherein a current reductant loading of one or both of the CCSCR 170 and DSCR 180 is maintained. In particular, in step 450 the CCSCR 170 may be maintained substantially depleted and the DSCR 180 may continue to be loaded with reductant by the second injector 185 under control of the controller 110. If the regeneration event 570 is complete, or almost complete, the method 400 moves to block 460.

In block 460 a reductant loading of the CCSCR 460 is increased. Block 460 comprises the controller 110 controlling the reductant injected to the close-coupled SCR 170. In particular, embodiments of block 460 comprise the controller 110 outputting the first reductant control signal 176 to control the first injector 175 to increase an amount or rate of reductant injected to the close-coupled SCR 170. In the example of FIG. 5, the first injector 175 is controlled by the controller 110 to increase the reductant load in anticipation of the end 540 of the regeneration event 570. Referring to the upper portion of FIG. 5, it can be appreciated that the reductant load of the CCSCR 170 is increased more quickly than in some prior art systems. When the reductant load is increased, a reductant loading command or instruction to increase the reductant loading incurs a delay before the reductant loading is increased. In the prior art, the injector is controlled to increase the reductant loading following the end of the regeneration event, however the reductant loading may only increase after a delay e.g. for hardware response of the injector etc. In practice, this delay may be upward of 10 seconds following the regeneration event 570. In embodiments of the invention, the end of the regeneration event may be predicted and the system prepared to increased the reductant loading at the time of the end of the regeneration event 570. For example, by instructing the injector to increase reductant loading ahead of the end of the regeneration event 570, hydraulic pressure may be increased, the injector energised etc such that reductant may be injected substantially at the same time as the end of the regeneration event 570, or even ahead of the end of the event 570, such that reductant loading increases earlier as shown in FIG. 5.

In block 470 a reductant loading of the DSCR 180 i.e. the second SCR 180 is reduced. Block 430 comprises the controller 110 being arrange to reduce the reductant loading of the second SCR 180 of the vehicle 200 in response, to or in anticipation of, completion or the end 540 of the regeneration event 570. In some embodiments the controller 110 is arranged to reduce in block 430 the reductant loading of the DSCR 180 prior to the end 540 of the regeneration event 570. The reductant loading of the DSCR 180 may be reduced proportional to the increase in loading of the CCSCR 170 in some embodiments.

In this way, it can be appreciated that embodiments of the present invention provide improved control of emissions of the vehicle 200 by managing reductant loading of the CCSCR or first SCR 170 in relation to a regeneration event 570 of an emissions trap 160 which influences an efficiency of operation of the CCSCR or first SCR 170 by heating the CCSCR 170. Emissions of the vehicle are reduced in some embodiments by correspondingly controlling the reductant load of the DSCR or second SCR 180 which is less thermally coupled to the emissions trap 160

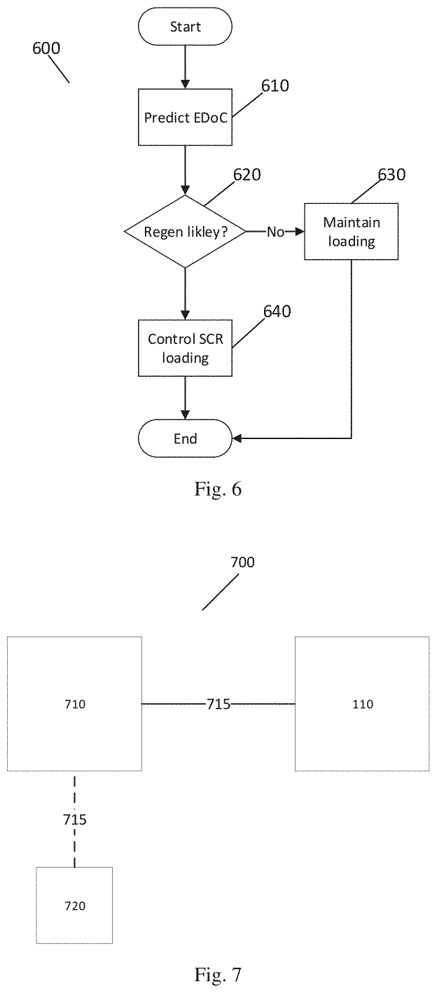

A method 600 according to another embodiment will now be explained with reference to FIGS. 6 to 8. The method 600 is a method for controlling a reductant loading of one or more SCR 170, 180. The method 600 may be performed by the system 100 shown in FIG. 1. The memory 120 of the controller 110 may store computer readable instructions which, when executed by the processor 110, perform an embodiment of the method 600. The method 600 is performed to control the reductant loading of a SCR 170, 180 of a vehicle 200. The method 600 may control the reductant loading of a vehicle with one SCR, such as the CCSCR 170, or a vehicle with more than one SCR such as the CCSCR 170 and the DSCR 180.

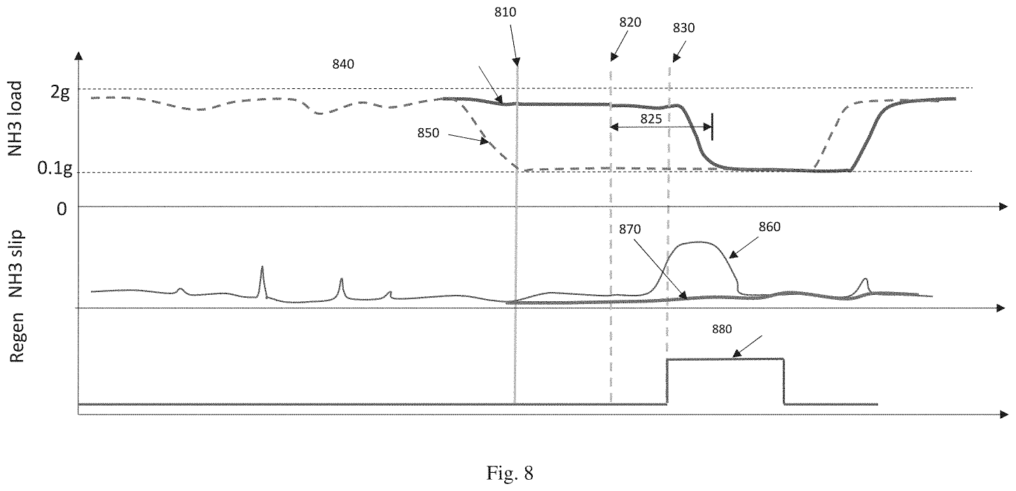

In block 610 of the method 600, the processor 120 of the controller 110 is arranged to determine a prediction of an end of a current driving cycle (EoDC) event 810 of the vehicle 200. The predicted EoDC 810 is illustrated as occurring at a point in time in FIG. 8. The prediction of the EoDC 810 is an indication of when operation of the ICE of the vehicle 200 will end. The EoDC 810 finishes or terminates a current driving cycle of the vehicle 200. The prediction of the EoDC 810 enables a predicted loading of the emissions trap 160, such as the LNT, DPF or GPF 160 at the end of the current driving cycle 810 to be determined in dependence thereon. In some embodiments, as described below, an indication associated with the prediction of the EoDC 810 may be received from a navigation system 710 of the vehicle 200. The prediction of the EoDC 810 may comprise one or more of an indication of a duration of time remaining to the EoDC 810, a distance of travel of the vehicle 200 until the EoDC 810, or a load of one or more oxides of nitrogen such as NOₓ adsorbed by the emissions trap 160 or a soot load of the emissions trap 160 in the case of the DPF or GPF, which are predicted to be emitted by the ICE until the EoDC 810.

The EoDC 810 is often triggered by a key-off or shutdown command at the vehicle 200 which ceases combustion at the ICE. For example, the EoDC 810 occurs when the vehicle 200 is stopped i.e. parked. A load of the emissions trap 160 is maintained i.e. is static after the EoDC 810 whilst the ICE is non-operational.

After a period of time following the EoDC 810, a next driving cycle (NDC) event 820 occurs where the ICE of the vehicle 200 begins combustion. Although usually triggered by a key-on event or start-up command at the vehicle i.e. from a driver of the vehicle 200, the NDC 820 event may be instructed remotely e.g. from a mobile device of the driver, or in response to a timer set by a user of the vehicle e.g. to being pre-heating of the vehicle 200 before use to make a journey. Often, a period of time elapses between the EoDC 810 and NDC 820 events, such that the emissions trap 160 associated with the exhaust system 150 e.g. LNT 160 or DPF 160 has substantially cooled, potentially to ambient temperature or has at least dropped in temperature from its respective operating temperature. Therefore, after the NDC event 820 a period of time for heating of the emissions trap 160 is required before the emissions trap 160 reaches a purge temperature to allow a regeneration event or process of the emissions trap 160 to begin. The purge temperature is the temperature at which the regeneration event is able to begin. Typically the purge temperature of the LNT 160 is around 220° C., although other temperatures can be utilised. The purge temperature is greater than the operating temperature of the LNT 160, thus a period of time is required to firstly reach the operating temperature, then the purge temperature of the LNT 160. In the case of the DPF or GPF, the purge temperature may be even higher, such as above 500° C. e.g. 600° C.

FIG. 7 illustrates a system 700 comprising the controller 110 shown in FIG. 1. It will be appreciated that other components, such as the emissions trap 160 are omitted from FIG. 7 for clarity. The controller 110 is communicably coupled to a navigation system 710 associated with the vehicle 200. The controller 110 and navigation system 710 are communicably coupled by an interface 715 of the vehicle 200 which may be a network 715 adhering to a relevant communications protocol such as a CAN Bus network, with other protocols including CANFD, Flexray, Ethernet and SENT networks for example.

The navigation system 710 may have been provided with an indication of an intended destination of the vehicle e.g. by the driver providing an input indicative of an address or a point of interest (POI) to which the driver intends to travel. The input may be provided as a selection on a graphical user interface of the navigation system 710 or as an audible input, for example.

The navigation system 710 may be arranged to infer the destination of the vehicle 200. The intended destination of the vehicle 200 may be inferred based on data indicative of regular routes or journeys undertaken by the vehicle 200 which is stored accessible to the navigation system 710.

For example, the location of the vehicle 200 and/or the time of day may be indicative of the intended destination. For example, if the vehicle 200 is parked at a place of work and a journey of the vehicle begins at a time generally corresponding to a regular commute home, the vehicle 200 location and time are strongly suggestive intended destination. In some embodiments, an identity of the driver of the vehicle 200 may be utilised in the inference of the intended destination. The identity of the driver of the vehicle 200 may be inferred in dependence on an identity of an electronic device associated or carried by the driver, such as an electronic key for accessing the vehicle 200, or other indications such as provided from a facial recognition system associated with the vehicle 200. Other sources of information indicative of the identity of the driver may be envisaged.

In some embodiments, the navigation system 710 is communicably coupled, such as over a wired or wireless communication channel 715, e.g. Bluetooth, with a portable electronic device 720 associated with a user of the vehicle 200, such as the driver of the vehicle. The portable electronic device 720 may be a portable computing device, such as a tablet, or a portable communications device such as a mobile telephone or smartphone 720. Although FIG. 7 shows the navigation system 710 being directly coupled to the device 720 it will be realised that the coupling may be indirect via one or other devices or links associated with the vehicle. The device 720 and the navigation system 710 may communicate such that the navigation system 710 is provided with an indication of the identity of the driver from the device 720 on which the inference of the destination of the vehicle 200 can be based. The device 720 may alternatively provide an indication of the destination of the vehicle 200 to the navigation system. For example, the driver may select the destination using software executing on the device 720 e.g. navigation software executing on the device 720 which provides the indication to the navigation system 710. In dependence on the destination of the vehicle 200, the controller 110 may determine the prediction of the EoDC 810 of the vehicle 200.

In some embodiments, based on the destination of the vehicle 200, either explicitly identified by the driver or inferred by the navigation system 710, the navigation system 710 may determine a prediction of a period of time for which the vehicle 200 will be operational or travelling before reaching the destination, or a route to be followed by the vehicle 200 to the destination.

Based on the destination of the vehicle 200, in some embodiments on the predicted operational period or route, a loading of the emissions trap 160 during the current driving cycle i.e. before the EoDC 810 may be determined by the processor 120.

The prediction of the loading of the emissions trap 160 may be determined in dependence on an e-horizon system associated with the vehicle. The e-horizon system associated with the vehicle 200 may be associated with the navigation system 710. The e-horizon system may provide data indicative of gradients or elevations associated with map data, such that an indication of torque demand from the ICE for the vehicle 200 to travel the route to the destination may be determined or estimated. In this way, emissions from the ICE may be estimated for the route. The loading of the emissions trap 160 for the route may be determined in dependence on data from the e-horizon system. The predicted loading of the emissions trap 160 may be determined in dependence on the identity of the driver in some embodiments. It is expected that each driver of the vehicle has an associated driving style, with an associated emissions load. For example, one driver may be relatively economical whereas another driver may have a more purposeful driving style, each exhibiting a different, respective, emissions load on the vehicle 200. By storing data indicative of the driving style or emissions load associated with the identity of each driver of the vehicle 200, the NOₓ output associated with the identified driver may be used to determine the loading of the emissions trap 160 for the current driving cycle in dependence on the predicted EoDC 810.

Block 620 comprises determine a likelihood of a regeneration event 880 of the emissions trap 160 in a next driving cycle of the vehicle 200 i.e. after the NDC event 820. In some embodiments. block 620 comprises determining whether a likelihood exists which is greater than a predetermined likelihood of the emissions trap 160 requiring purging or regeneration in the next driving cycle of the vehicle 200. In some embodiments, block 620 comprises determining whether the emissions trap 160 will require purging or regeneration within a predetermined period of time, such as at least 15 minutes or around 20 minutes, as indicated by arrow 825, of the NDC event 820 i.e. after the NDC event 820 in the next driving cycle of the vehicle 200.

In some embodiments of block 620, the likelihood is determined in dependence on the prediction of the EoDC 810. By way of example, reference will be described of determining whether the LNT 160 requires purging or regeneration. In some embodiments, the determining the likelihood of a regeneration event 880 in the next driving cycle comprises receiving the signal 166 indicative of a current capacity of the LNT 160. The controller 110 may receive the LNT load signal 166 indicative of the current load of the LNT 160 at a time during the current driving cycle prior to the EoDC 810. Based on the current load of the LNT 160 in the current driving cycle, a prediction of a remaining capacity of the LNT 160 at the predicted EoDC 550 may be determined in block 620. If the remaining capacity at the EoDC 810 is relatively low, such as below a predetermined minimum threshold capacity, the controller 110 may determine a high likelihood of the regeneration event 880 in the next driving cycle, such as within time period 825 after the NDC even 820. The predetermined remaining minimum threshold capacity may be, for example, 25%, 15% or 10% of the total NOₓ capacity of the LNT 160. For example 25% of the total capacity may be 0.5 g of NOₓ at the EoDC 810. If the predicted remaining capacity of the LNT 160 at the EoDC 810 is equal to or below the minimum threshold capacity, the likelihood may be determined as being above the likelihood threshold. Otherwise, if the predicted remaining capacity of the LNT 160 is greater than the minimum threshold capacity, the likelihood may be determined as below the likelihood threshold.

If, in block 620 it is determined that the regeneration event 880 is likely, the method 600 moves to block 640. Otherwise, if it is determined that the regeneration event 880 is unlikely, the method moves to block 630. In block 630 a reductant loading of one or more of the SCRs 170, 180 is maintained. In particular, in block 830 in some embodiments, the controller 110 may maintain a reductant loading of the first or CCSCR 170 such that it is operative to treat emissions from the ICE of the vehicle 200. The controller 110 may control the first injector 175 to inject reductant to operatively load the CCSCR 170 to treat emissions from the ICE.

In block 640 a reductant loading of one or more SCRs 170, 180 of the vehicle 200 is controlled. In some embodiments, the reductant loading of the CCSCR 170 is controlled. In some embodiments, the reductant loading of the CCSCR 170 and the DSCR 180 is controlled in block 640.

In block 640 the reductant loading of the CCSCR 170, i.e. the first SCR 170, is reduced in dependence on the likelihood of the regeneration event 880 after the NDC event 820. The reductant loading of the CCSCR 170 is reduced prior to the EoDC event 810, as indicated by trace 850 in FIG. 8. Block 640 comprises the controller 110 controlling the reductant injected to the CCSCR 170. In particular, embodiments of block 640 comprise the controller 110 outputting the first reductant control signal 176 to control the first injector 175 to reduce an amount or rate of reductant injected to the CCSCR 170. The first injector 175 is controlled by the controller 110 to reduce the reductant load prior to the EoDC event 810. In this way, immediately following the NDC event 820 the CCSCR 170 is depleted of reductant which reduces ammonia slippage following the NDC event 820 as illustrated by comparison of ammonia slippage in the prior art as indicated by trace 860 and trace 870 illustrated ammonia slippage from the SCR according to an embodiment of the present invention.

In some embodiments of block 640 the reductant loading of the DSCR 180 i.e. the second SCR 180 is increased in dependence on the likelihood of the regeneration event 880 after the NDC event 820. In some embodiments, the reductant loading of the DSCR 180 is increased prior to the EoDC event 810. Block 640 may comprise the controller 110 being arrange to increase the reductant loading of the DSCR 180 of the vehicle 200 in dependence on the likelihood of the upcoming regeneration event 570. The reductant loading of the DSCR 180 may be increased proportional to the decrease in the reductant loading of the CCSCR 170. In other embodiments, the loading of the DSCR 180 may be increased in advance of the reduction in loading of the CCSCR 170. Advantageously the DSCR 180 is able to treat emissions from the engine of the vehicle 200 as the CCSCR 170 reductant loading is reduced. In this way, at a time of the regeneration event 880 after the NDC event 820, the DSCR is able to treat emissions from the ICE.

After the regeneration event 880, the reductant loading of the CCSCR may be increased, as shown in FIG. 8 by trace 850 which increases following the regeneration event. In some embodiments, the controller 110 may increase the reductant loading of the CCSCR 170 in anticipation of an end of the regeneration event 800, as discussed above. In some embodiments, the controller 110 may decrease the reductant loading of the DSCR 180 following the regeneration event 880.

It will be appreciated that various changes and modifications can be made to the present invention without departing from the scope of the present application.

1. A control system for a vehicle, the control system comprising one or more controller, the control system being arranged to:
determine a prediction of an end of a current driving cycle of the vehicle;
determine a likelihood of a regeneration event of an emission control device in a next driving cycle of the vehicle; and
reduce a reductant loading of a selective catalyst reduction system of the vehicle prior to the end of the current driving cycle in dependence on the likelihood of the regeneration event.

2. The control system of claim 1, wherein the control system comprises an output arranged to output a reductant control signal for controlling the reductant loading of the selective catalyst reduction system.

3. The control system of claim 2, wherein the reductant control signal is for controlling an injector associated with the selective catalyst reduction system.

4. The control system of claim 1, wherein the determining the likelihood of the regeneration event of the emissions control device comprises determining a likelihood of the regeneration event within a predetermined period of time from a start of the next driving cycle.

5. The control system of claim 4, wherein the predetermined period of time is at least 15 minutes.

6. The control system of claim 4, wherein the start of the next driving cycle is determined from a start of an engine of the vehicle.

7. The control system of claim 1, wherein the reducing the reductant loading comprises substantially depleting the selective catalyst reduction system of reductant prior to the end of the current driving cycle.

8. The control system of claim 7, wherein the reductant control signal is for controlling an injector associated with the selective catalyst reduction system and wherein the depleting the selective catalyst reduction system of reductant prior to the end of the current driving cycle comprises outputting the reductant control signal to control the injector to reduce injection of the reductant, such that the selective catalyst reduction system is substantially unloaded prior to the end of the current driving cycle.

9. The control system of claim 1, wherein the reductant loading of the selective catalyst reduction system is reduced at least 5 minutes prior to the end of the current driving cycle.

10. The control system of claim 1, wherein the control system is arranged to:
determine an end of the regeneration event of the emission control device; and
increase the reductant loading of the selective catalyst reduction system of the vehicle in dependence on the end of the regeneration event.

11. The control system of claim 1, wherein the selective catalyst reduction system is a first selective catalyst reduction system located proximal to the emission control device in an exhaust system of the vehicle.

12. The control system of claim 11, wherein the control system is arranged to increase a reductant loading of a second selective catalyst reduction system of the vehicle in dependence on the likelihood of the upcoming regeneration event, the second selective catalyst reduction system being located distal to the emission control device in the exhaust system.

13. The control system of claim 1, wherein the emission control device is a diesel particulate filter.

14. The control system of claim 1, wherein the reductant is an urea-based reductant.

15. The control system of claim 1 comprised in a system for a vehicle, the system further comprising a selective catalyst reduction system, wherein the control system is arranged to control a reductant loading of the selective catalyst reduction system.

16. The control system of claim 15, comprising a reductant injector controlled by the control system, wherein the injector is arranged to inject reductant to the selective catalyst reduction system.

17. The control system of claim 1 comprised in a vehicle.

18. A method of controlling a selective catalyst reduction system, the method comprising:
determining a prediction of an end of a current driving cycle of the vehicle;
determining a likelihood of a regeneration event of an emission control device in a next driving cycle of the vehicle; and
reducing a reductant loading of a selective catalyst reduction system of the vehicle prior to the end of the current driving cycle in dependence on the likelihood of the regeneration event.

19. A non-transitory, computer-readable storage medium storing instructions thereon that, when executed by one or more electronic processors, causes the one or more electronic processors to carry out the method according to claim 18.
